(19) United States
(12) Patent Application Publication
(10) Pub. No.: US 2015/0229002 A1
(43) Pub. Date: Aug. 13, 2015

(54) NONAQUEOUS ELECTROLYTE SECONDARY BATTERY AND METHOD FOR PRODUCING NONAQUEOUS ELECTROLYTE SECONDARY BATTERY

(71) Applicant: GS Yuasa International Ltd., Kyoto-shi, Kyoto (JP)

(72) Inventors: Yudai Kawasoe, Kyoto (JP); Katsushi Nishie, Kyoto (JP); Takeshi Hachida, Kyoto (JP)

(21) Appl. No.: 14/426,025

(22) PCT Filed: Sep. 2, 2013
(86) PCT No.: PCT/JP2013/005180

§ 371 Date: Mar. 4, 2015

(30) Foreign Application Priority Data
Sep. 6, 2012 (JP) 2012-196037

(51) Int. Cl. H01M 10/0567

(52) U.S. Cl. CPC H01M 10/0567; H01M 2220/30; H01M 2300/004

(57) ABSTRACT

Provided is a nonaqueous electrolyte secondary battery comprising a nonaqueous electrolyte. A lithium phosphate compound and a cyclic sulfone compound are contained in the nonaqueous electrolyte. The lithium phosphate compound is contained in an amount greater than 0% by mass and less than or equal to 4.0% by mass relative to the whole mass of the nonaqueous electrolyte. The cyclic sulfone compound is contained in an amount greater than 0% by mass and less than or equal to 3.0% by mass relative to the whole mass of the nonaqueous electrolyte. The lithium phosphate compound comprises lithium difluoro(bisoxalato) phosphate and lithium tetrafluoro(oxalato) phosphate.

### TECHNICAL FIELD

The present invention relates to a nonaqueous electrolyte secondary battery and a method for producing a nonaqueous electrolyte secondary battery.

### BACKGROUND ART

A nonaqueous electrolyte secondary battery such as a lithium ion secondary battery has been widely used as a power source for portable equipment such as a mobile phone since the nonaqueous electrolyte secondary battery has a high energy density as compared to other secondary batteries such as a lead-acid battery and an alkaline secondary battery. In recent years, research and development for the purpose of using a nonaqueous electrolyte secondary battery as a power source for a mobile body such as an electric vehicle have been actively conducted.

In the nonaqueous electrolyte secondary battery such as a lithium ion secondary battery, lowering in battery performance such as a decrease in discharge capacity and an increase in internal resistance occurs during the charge-discharge repeatedly performed or long-term storage while the battery has a high energy density. The lowering in battery performance is mainly caused by the reaction of an electrode plate and a nonaqueous electrolyte. In order to suppress the lowering in battery performance, an investigation for the purpose of adding various additive reagents to the nonaqueous electrolyte has been conducted.

In JP-A-2011-222193, there has been shown a procedure of allowing a difluoro(oxalato) phosphate and a tetrafluoro(oxalato) phosphate as additive reagents for the nonaqueous electrolyte to be contained, and it has been described that a battery excellent in durability and low-temperature properties is provided.

### PRIOR ART DOCUMENT

### Patent Document

Patent Document 1: JP-A-2011-222193

### SUMMARY OF THE INVENTION

### Problems to be Solved by the Invention

With regard to the nonaqueous electrolyte secondary battery mounted as a power source into a mobile body such as a battery car and a hybrid automobile, in general, a plurality of batteries are combined to be mounted as a module thereinto. Although batteries in which the charge-discharge has been performed several times are used for assembling the module, when gas is generated inside the battery during this charge-discharge performed several times and the battery is expanded, there is a difficulty in assembling the module or the like occurs.

In addition to this, a battery for a mobile body use is used over a long period of time as compared to those for conventional uses such as portable equipment and the like. Moreover, a battery for a mobile body use is used in a severe environment where the temperature of the battery may become a high temperature of around 60° C. depending on places at which the battery is mounted in the case of being used during a summer period. In a battery for a mobile body use, after use over a long period of time or use in a severe environment, the decomposition of an electrolyte solution is promoted, a large amount of gas is generated inside the battery, and the battery is expanded. When the expansion of the battery occurs, there are difficulties such that the battery mounting part of the mobile body is deformed and a trouble occurs, and the safety mechanism of the battery is operated in the case where the inner pressure is extremely increased.

### Means for Solving the Problems

The present inventors have conducted diligent studies on various additive reagents for the nonaqueous electrolyte in view of solving the above problems, and as a result, they have found that by adding a specific compound to the nonaqueous electrolyte, it is possible to remarkably suppress both the gas evolution associated with the charge-discharge performed several times immediately after the completion of the battery and the gas evolution at the time when the battery is used for a long period of time at a high temperature.

The first aspect of the present application provides a nonaqueous electrolyte secondary battery including a nonaqueous electrolyte in which a lithium phosphate compound and a cyclic sulfone compound are contained. The lithium phosphate compound is contained in an amount greater than 0% by mass and less than or equal to 4.0% by mass relative to the whole mass of the nonaqueous electrolyte. The cyclic sulfone compound is contained in an amount greater than 0% by mass and less than or equal to 3.0% by mass relative to the whole mass of the nonaqueous electrolyte. The lithium phosphate compound comprises lithium difluoro(bisoxalato) phosphate represented by the following formula (1) and lithium tetrafluoro(oxalato) phosphate represented by the following formula (2).

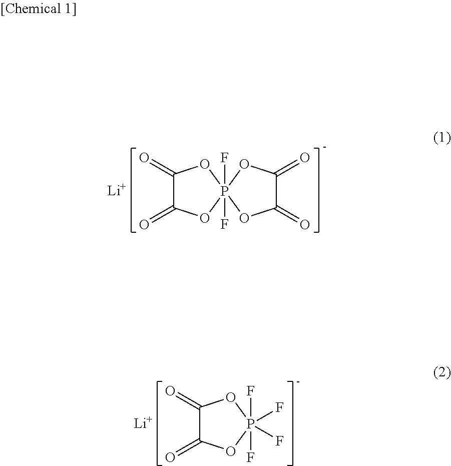

According to the above-mentioned constitution, it is possible to suppress both the gas evolution associated with the charge-discharge performed several times immediately after the completion of the battery and the gas evolution at the time when the battery is used for a long period of time at a high temperature.

In the battery according to the second aspect of the present application, the content of the lithium tetrafluoro(oxalato) phosphate constituting the lithium phosphate compound in the battery according to the first aspect is 0.05 to 0.3 time the content of the lithium difluoro(bisoxalato) phosphate.

According to the above-mentioned constitution, it is preferred because both the gas evolution associated with the charge-discharge performed several times immediately after the completion of the battery and the gas evolution at the time when the battery is used for a long period of time at a high temperature can be remarkably suppressed.

According to the third aspect of the present application, in the battery according to the first or second aspect, the cyclic sulfone compound is an unsaturated cyclic sultone compound represented by the following formula (3).

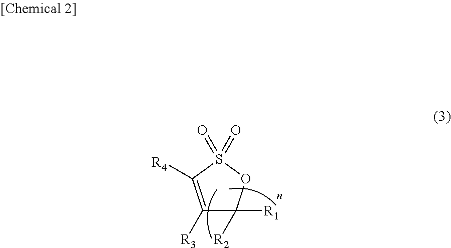

(In the formula, R1, R2, R3 and R4 each represent a hydrogen atom, a fluorine atom or a hydrocarbon group with 1 to 4 carbon atoms which may contain a fluorine atom, and n represents an integer of 1 to 3.)

According to the above-mentioned constitution, it is preferred because the gas evolution at the time when the battery is used for a long period of time at a high temperature can be remarkably suppressed.

Moreover, the fourth aspect of the present application provides a method for producing a nonaqueous electrolyte secondary battery prepared with a nonaqueous electrolyte, the method including the step of using the nonaqueous electrolyte containing a lithium phosphate compound in an amount greater than 0% by mass and less than or equal to 4.0% by mass relative to the whole mass of the nonaqueous electrolyte, containing a cyclic sulfone compound in an amount greater than 0% by mass and less than or equal to 3.0% by mass relative to the whole mass of the nonaqueous electrolyte, and the lithium phosphate compound containing lithium difluoro(bisoxalato) phosphate represented by the following formula (1) and lithium tetrafluoro(oxalato) phosphate represented by the following formula (2).

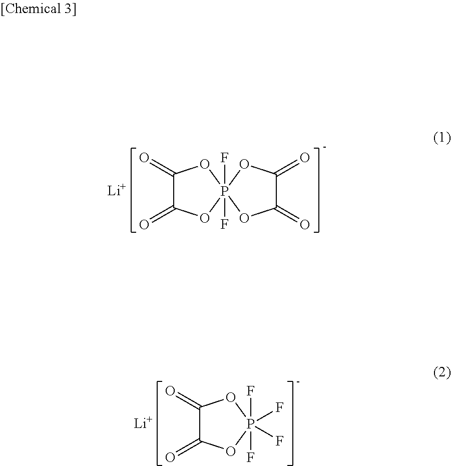

### BRIEF DESCRIPTION OF THE DRAWINGS

FIG. 1: A cross-sectional view of a nonaqueous electrolyte secondary battery in accordance with Embodiment 1

### MODE FOR CARRYING OUT THE INVENTION

Hereinafter, the embodiment according to the present invention will be described in detail. The description described below is an example of the embodiment according to the present invention, the present invention should not be limited to these contents without departing from the gist thereof.

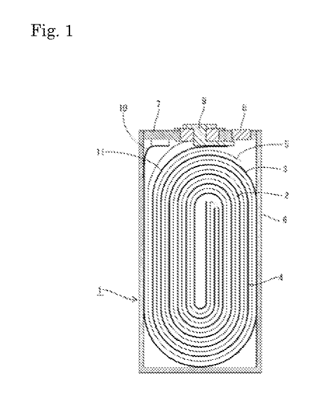

Embodiment 1 of the present invention will be described with reference to FIG. 1. A nonaqueous electrolyte secondary battery (hereinafter, referred to as “secondary battery”) shown in FIG. 1 is provided with a power generating element prepared by spirally winding a positive electrode plate and a negative electrode plate with a separator interposed therebetween. The positive electrode plate is prepared by applying a positive composite containing a positive active material on both faces of a positive current collector composed of aluminum foil or aluminum alloy foil. The negative electrode plate is prepared by applying a negative composite containing a negative active material on both faces of a negative current collector composed of copper foil. The power generating element is housed in a battery case.

The positive electrode plate is connected to a battery lid through a positive electrode lead. The negative electrode plate is connected to a negative electrode terminal provided to the battery lid. The battery lid is attached by laser beam welding so as to close the opening part of a battery case. A hole is bored in the battery case. A nonaqueous electrolyte is injected into the battery case through the hole. A nonaqueous electrolyte secondary battery is obtained by sealing the hole after the nonaqueous electrolyte is injected.

As the nonaqueous electrolyte in the present invention, one prepared by dissolving an electrolyte salt in a nonaqueous solvent is used. Examples of the electrolyte salt include LiClO₄, LiPF₆, LiBF₄, LiAsF₆, LiCF₃CO₂, LiCF₃(CF₃)₃, LiCF₃(C₂F₃)₃, LiCF₃SO₃, LiCF₃CF₂SO₃, LiCF₃CF₂CF₂SO₃, LiN(SO₂CF₃)₃, LiN(SO₂CF₂CF₃)₂, LiN(COCF₃)₂, LiN(COCF₂CF₃)₂, LiPF₃(CF₂CF₃)₃ and the like, and these electrolyte salts can be used alone or mixedly in combination of two or more kinds thereof. From the viewpoint of electrical conductivity, LiPF₆ is suitable as the electrolyte salt, and an electrolyte salt which is composed mainly of LiPF₆ and prepared by being mixed with another electrolyte salt such as LiBF₄ can also be used.

As the nonaqueous solvent of the nonaqueous electrolyte, ethylene carbonate, propylene carbonate, butylene carbonate, trifluoropropylene carbonate, γ-butyrolactone, sulfolane, 1,2-dimethoxyethane, tetrahydrofuran, methyl acetate, ethyl acetate, methyl propionate, ethyl propionate, dimethyl sulfoxide, dimethyl carbonate, diethyl carbonate, ethyl methyl carbonate, dipropyl carbonate, methyl propyl carbonate, dibutyl carbonate, and the like can be used. It is preferred that these nonaqueous solvents be mixed and used from the viewpoint of adjusting the electrical conductivity and the viscosity of the nonaqueous electrolyte.

In the nonaqueous electrolyte in the present invention, a lithium phosphate compound containing lithium difluoro(bisoxalato) phosphate represented by a general formula (1) and lithium tetrafluoro(oxalato) phosphate represented by a general formula (2) and a cyclic sulfone compound are contained.

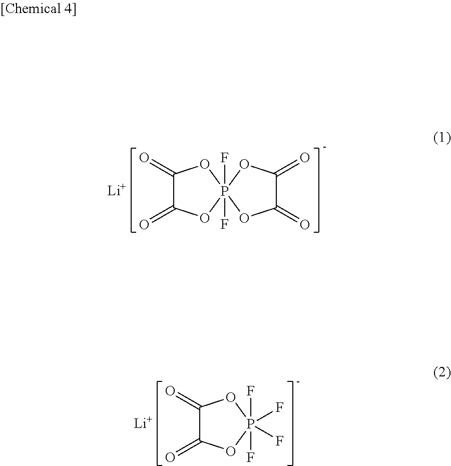

Specific examples of the cyclic sulfone compound include 1,3-propane sultone, 1,3-propene sultone, ethylene sulfite, 1,2-propylene glycol sulfite, vinyl ethylene sulfite, pentene glycol sulfate, methylene methane disulfonate, ethylene methane disulfonate, propylene methane disulfonate, 2,4-diethyl-1,3-dithietane-1,1,3,3-tetraone, 2-(methylethyl)-1,3-dithietane-1,1,3,3-tetraone, 2,4-bis(methylethyl)-1,3-dithietane-1,1,3,3-tetraone, 4-(2,2-dioxo-1,3,2-dioxathiolane-4-yl)-1,3,2-dioxathiolane-2,2-dione, (2,2-dioxo-1,3,2-dioxathiolane-4-yl) methyl methyl sulfonate, and the like. Then, in particular, it is preferred that the cyclic sulfone compound be an unsaturated cyclic sultone compound represented by the following formula (3). Moreover, these compounds can be mixed and added to the nonaqueous electrolyte.

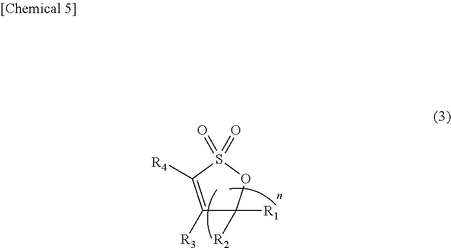

(In the formula, R1, R2, R3 and R4 each represent a hydrogen atom, a fluorine atom or a hydrocarbon group with 1 to 4 carbon atoms which may contain a fluorine atom, and n represents an integer of 1 to 3.)

Specific examples of the unsaturated cyclic sultone compound represented by the general formula (3) include 1,3-propene sultone and the like. Moreover, these compounds can be mixed and added to the nonaqueous electrolyte.

In the nonaqueous electrolyte secondary battery according to the present invention, a lithium phosphate compound containing lithium difluoro(bisoxalato) phosphate represented by the general formula (1) and lithium tetrafluoro(oxalato) phosphate represented by the general formula (2) in an amount greater than 0% by mass and less than or equal to 4.0% by mass relative to the whole mass of the nonaqueous electrolyte are contained and a cyclic sulfone compound in an amount greater than 0% by mass and less than or equal to 3.0% by mass relative to the whole mass of the nonaqueous electrolyte is contained in the nonaqueous electrolyte. Consequently, it is possible to suppress both the gas evolution associated with the charge-discharge performed several times immediately after the completion of the battery and the gas evolution at the time when the battery is used for a long period of time at a high temperature. Although the details of the mechanism allowing the gas evolution to be suppressed in both the two cases have not yet been elucidated, it is thought that at an early stage of using a battery (at the time of charge-discharge performed several times immediately after the completion of a battery), these additive reagents react with a positive active material or a negative active material, and a stable protective film which is relatively thick is formed on the electrode surface. Since this protective film has a chemical composition differing from that of a protective film formed by using respective compounds used in the present invention alone, it is thought that the amount of gas generated at the time of forming the protective film is reduced. Moreover, this protective film is strong even under high temperatures and under long-term use, since the solvent of the nonaqueous electrolyte and the electrode are suppressed from reacting with each other even in the case where the battery is used for a long period of time at a high temperature, it is thought that the amount of gas generated can be reduced.

The amount of the lithium phosphate compound relative to the whole mass of the nonaqueous electrolyte is greater than 0% by mass and less than or equal to 4.0% by mass, preferably greater than or equal to 0.1% by mass and less than or equal to 4.0% by mass, and further preferably greater than or equal to 0.5% by mass and less than or equal to 2.0% by mass. When the amount of the lithium phosphate compound is greater than 4.0% by mass, the reaction of the lithium phosphate compound and the electrode becomes excessive, and with the progress of the decomposition of oxalic acid groups contained in the lithium phosphate compound, a large amount of gas is generated at the time of charge-discharge performed immediately after the completion of a battery. Moreover, even after the charge-discharge, since residual components decompose, the gas evolution is intermittently continued. On the other hand, when the amount of the lithium phosphate compound is 0% by mass, it is difficult to form a strong protective film and the decomposition of the electrolyte solution cannot be suppressed.

The amount of the cyclic sulfone compound relative to the whole mass of the nonaqueous electrolyte is greater than 0% by mass and less than or equal to 3.0% by mass, preferably greater than or equal to 0.1% by mass and less than or equal to 2.0% by mass, and further preferably greater than or equal to 0.5% by mass and greater than or equal to 1.0% by mass. When the amount of the cyclic sulfone compound is greater than 3.0% by mass, it is not preferred because the cyclic sulfone compound is not completely dissolved in the nonaqueous electrolyte and further enhancement in performance cannot be expected. On the other hand, when the amount of the cyclic sulfone compound is 0% by mass, it is impossible to form a strong protective film which is to be formed by allowing a lithium phosphate compound and a cyclic sulfone compound to be decomposed.

Other than the above-mentioned compounds, for the purposes of the enhancement in cycle life performance and the enhancement in safety of a battery, a kind of carbonate such as vinylene carbonate, methylvinylene carbonate, monofluoroethylene carbonate and difluoroethylene carbonate; a kind of vinyl ester such as vinyl acetate and vinyl propionate; a kind of aromatic compound such as benzene and toluene; a halogen-substituted alkane such as perfluorooctane; a kind of silyl ester such as tristrimethylsilyl borate, tristrimethylsilyl phosphate and tetrakistrimethylsilyl titanate; and the like can be used alone or mixedly in combination of two or more kinds thereof to be added to the nonaqueous electrolyte.

A positive active material for a positive electrode plate in the nonaqueous electrolyte secondary battery according to the present invention is not particularly limited, and various positive active materials can be used. For example, composite oxides composed of lithium and a transition metal represented by general formulas LiₓM1ₚO_{2-δ}, LiₓM2_{q}O_{4-δ} and LiₓM₃RO₄ (provided that M1, M2 and M3 are at least one metal selected from Co, Ni, Mn and Fe, R is at least one kind of typical element selected from P, S and Si, 0.4≦x≦1.2, 0.85≦p≦1.2, 1.5≦q≦2.2, 0≦δ≦0.5), or compounds obtained by allowing at least one kind of element selected from Al, Fe, Cr, Ti, Zn, P and B to be contained in these composite oxides can be used.

In the positive electrode plate, other than the above-mentioned positive active materials, a conductive agent, a binding agent, and the like can be contained. As the conductive agent, acetylene black, carbon black, graphite and the like can be used. As the binding agent, polyvinylidene fluoride, a vinylidene fluoride-hexafluoropropylene copolymer, styrene-butadiene rubber, polyacrylonitrile and the like can be used alone or in mixture.

As a negative active material for a negative electrode plate in the nonaqueous electrolyte secondary battery according to the present invention, a carbon material, an alloy-based compound of Al, Si, Pb, Sn, Zn, Cd or the like and lithium, metallic lithium, a metal oxide represented by a general formula M4Oz (provided that M4 is at least one kind of element selected from W, Mo, Si, Cu and Sn, 0≦z≦2), and the like can be used. Of these, a carbon material is preferred, and as the carbon material, graphite, an amorphous carbon such as hardly graphitizable carbon and easily graphitizable carbon, and a mixture thereof can be used. Of these carbon materials, an amorphous carbon and a graphite material obtained by covering the surface with an amorphous carbon are more preferred because the reactivity between the material surface and an electrolyte solution is lowered. In the negative electrode plate, as in the case of the positive electrode plate, a binding agent such as polyvinylidene fluoride and styrene-butadiene rubber, and the like can be added.

The separator needs to be one capable of electrically separating the positive electrode plate and the negative electrode plate from each other, and nonwoven fabric, a synthetic resin-made microporous membrane, and the like can be used. In particular, the synthetic resin-made microporous membranes are preferred from the viewpoints of processability and durability, and of these, a polyolefin-based microporous membrane composed of polyethylene and polypropylene, a heat-resistant resin-made microporous membrane prepared by providing an aramid layer on the surface of the polyolefin-based microporous membrane, and the like can be used.

### EXAMPLES

A secondary battery shown in FIG. 1 was produced in the following manner.

### 1. PREPARATION OF SECONDARY BATTERY IN EXAMPLE 2

### (1) Production of Positive Electrode Plate

Carbon-coated lithium iron phosphate was used as a positive active material, acetylene black was used as a conductive additive, and polyvinylidene fluoride was used as a binding agent. To a mixture containing the positive active material in 90% by mass content, the conductive additive in 5% by mass content, and the binding agent in 5% by mass content, respectively, a suitable amount of NMP (N-methylpyrrolidone) was added to prepare a viscosity-adjusted positive composite paste. By applying this positive composite paste on both faces of a sheet of aluminum foil with a thickness of 20 μm and drying the paste, a positive electrode plate was prepared. A portion where the positive composite is not applied and the aluminum foil is exposed was provided on the positive electrode plate, and the portion where the aluminum foil is exposed and a positive electrode lead were connected together.

### (2) Production of Negative Electrode Plate

Hardly graphitized carbon was used as a negative active material, and polyvinylidene fluoride was used as a binding agent. Tb a mixture containing the negative active material in 90% by mass content and the binding agent in 10% by mass content, respectively, a suitable amount of NMP was added to prepare a viscosity-adjusted negative composite paste. By applying this negative composite paste on both faces of a sheet of copper foil with a thickness of 15 μm and drying the paste, a negative electrode plate was prepared. A portion where the negative composite is not applied and the copper foil is exposed was provided on the negative electrode plate, and the portion where the copper foil is exposed and a negative electrode lead were connected together.

### (3) Preparation of Electrolyte Solution-Unfilled Secondary Battery

A separator composed of a polyethylene-made microporous membrane was interposed between the positive electrode plate and the negative electrode plate, and by spirally winding the positive electrode plate and the negative electrode plate, a power generating element was prepared. The power generating element was housed in a battery case through the opening part of the battery case, the positive electrode lead was connected to a battery lid, and the negative electrode lead was connected to a negative electrode terminal, after which the battery lid was fitted to the opening part of the battery case and the battery case and the battery lid were connected together by laser beam welding to prepare a secondary battery in a state of being electrolyte solution-unfilled in which a nonaqueous electrolyte is not injected into the battery case.

### (4) Preparation of Nonaqueous Electrolyte and Electrolyte Solution Filling

LiPF₆ was dissolved at a concentration of 1 mol/L in a mixed solvent of ethylene carbonate (EC): dimethyl carbonate (DMC): ethyl methyl carbonate (EMC)=3:2:5 (volume ratio). To the solution, lithium difluoro(bisoxalato) phosphate (hereinafter, [LiPF₂(Oₓ)₂]) in an amount that the content thereof becomes 0.09% by weight relative to the whole mass of the nonaqueous electrolyte, lithium tetrafluoro(oxalato) phosphate (hereinafter, [LiPF₄(Oₓ)]) in an amount that the content thereof becomes 0.01% by weight relative to the whole mass of the nonaqueous electrolyte, and 1,3-propene sultone as a cyclic sulfonic acid ester in an amount that the content thereof becomes 0.5% by weight relative to the whole mass of the nonaqueous electrolyte were added to prepare a nonaqueous electrolyte. This nonaqueous electrolyte was injected into the inside of the battery case through an electrolyte solution filling port bored in a side face of the battery case, after which the preliminary charge was performed for 2 hours at a constant current of 90 mA at 25° C. Furthermore, after allowed to stand for 1 hour, the electrolyte solution filling port was sealed with a plug to prepare a secondary battery in Example 1. In this connection, the design capacity of a secondary battery in Example 2 was set to 450 mAh.

### 2. PREPARATION OF SECONDARY BATTERIES IN EXAMPLES 3 TO 5, EXAMPLE 1 AND COMPARATIVE EXAMPLE 1

Batteries in Examples 3 to 5, Example 1 and Comparative Example 1 were prepared in the same manner as that for the battery in Example 2 except that the contents of [LiPF₂(Oₓ)₂] and [LiPF₄(Oₓ)] in Example 2 were set to 0.45%6 by mass and 0.05% by mass (Example 3), 1.8% by mass and 0.198% by mass (Example 4), 3.6% by mass and 0.398% by mass (Example 5), 0.045% by mass and 0.005% by mass (Example 1), and 4.0% by mass and 0.45% by mass (Comparative Example 1), respectively.

### 3. PREPARATION OF SECONDARY BATTERIES IN EXAMPLES 6 TO 10 AND COMPARATIVE EXAMPLE 2

Batteries in Examples 6 to 10 and Comparative Example 2 were prepared in the same manner as that for the battery in Example 2 except that the content of 1,3-propene sultone in Example 2 was set to 0.1% by mass, 0.05% by mass, 1.0% by mass, 2.0% by mass, 3.0% by mass and 0.00% by mass (not added).

### 4. PREPARATION OF SECONDARY BATTERIES IN EXAMPLES 11 TO 15

Batteries in Examples 11 to 15 were prepared in the same manner as that for the battery in Example 2 except that the contents of [LiPF₂(Oₓ)₂] and [LiPF₄(Oₓ)] in Example 2 were set to 0.485% by mass and 0.015% by mass (Example 11), 0.48% by mass and 0.024% by mass (Example 12), 0.42% by mass and 0.084% by mass (Example 13), 0.39% by mass and 0.117% by mass (Example 14), and 0.36% by mass and 0.144% by mass (Example 15), respectively.

### 5. PREPARATION OF SECONDARY BATTERIES IN EXAMPLES 16 TO 20

Batteries in Examples 16 to 20 were prepared in the same manner as that for the battery in Example 2 except that the 1,3-propene sultone in Example 2 was changed to methylene methane disulfonate, ethylene methane disulfonate, propylene methane disulfonate, pentene glycol sulfate, or 1,3-propane sultone.

### 6. EVALUATION TEST

### (1) Confirmation Test for Initial Capacity

Using respective batteries prepared in Examples 1 to 20 and Comparative Examples 1 and 2, the confirmation test for the initial discharge capacity was performed under the following charge-discharge condition. The charge was performed to a voltage of 3.55 V at a constant current of 4650 mA at 25° C., and furthermore, the charge was performed at a constant voltage of 3.55 V. The charge which includes the constant current charge and the constant voltage charge was performed for a total of 3 hours. After charging, the discharge was performed to an end-of-discharge voltage of 2.0 V at a constant current of 450 mA, and this discharge capacity is defined as “initial capacity”.

### (2) 60° C. Cycle Life Test

With regard to respective batteries after the confirmation test for the initial capacity, the 60° C. cycle life test was performed under the following condition. Performing the charge which includes the constant current charge and the constant voltage charge for a total of 30 minutes by performing the charge to a voltage of 3.4 V at a constant current of 900 mA at 60° C., and furthermore, performing the charge at a constant voltage of 3.4 V, and then, performing the discharge to a voltage of 2.6 V at a constant current of 900 mA at 60° C. is defined as 1 cycle. This cycle was repeated 3000 times. In this connection, after charging and after discharging, intervals of 10 minutes at 60° C. were provided. With regard to the battery after the completion of 3000 cycles, the charge-discharge was performed under the same condition as that in the confirmation test for the initial capacity. In this context, the charge voltage of 3.4 V and the end-of-discharge voltage of 2.6 V each are voltages corresponding to 90% (SOC of 90%) and 10% (SOC of 10%), respectively, calculated in the case where the capacity from the end-of-discharge voltage of 2.0 V to the charge voltage of 3.55 V in the confirmation test for the initial capacity is expressed as a percentage.

### (3) Measurement of Amount of Gas Generated

A hole was made in the battery case of a battery before the above-mentioned confirmation test for the initial capacity in a state of being placed in a hermetically sealed container with a syringe, and the amount of gas emitted was confirmed by a scale on the syringe. Moreover, after the confirmation test for the initial capacity and after the 60° C. cycle life test, the measurement of the amount of gas was performed in the same manner. In this context, the difference between the amounts of gas before and after the confirmation test for the initial capacity is defined as “initial amount of gas”. Moreover, the difference between the amounts of gas after the confirmation test for the initial capacity and after the 60° C. cycle test is defined as “increment of gas”.

TABLE 1

| | Amount of | Amount of | | Amount of | Initial | |
|---|---|---|---|---|---|---|
| | LiPF₂(Ox)₂ | LiPF₄(Ox) | | cyclic sulfone | amount | Increment |
| | added | added | Cyclic sulfone | compound added | of gas | of gas |
| | (% by mass) | (% by mass) | compound | (% by mass) | (mL) | (mL) |
| Example 1 | 0.045 | 0.005 | 1,3-Propene sultone | 0.5 | 2.70 | 9.74 |
| Example 2 | 0.090 | 0.010 | 1,3-Propane sultone | 0.5 | 0.90 | 3.51 |
| Example 3 | 0.450 | 0.050 | 1,3-Propene sultone | 0.5 | 0.80 | 2.61 |
| Example 4 | 1.800 | 0.198 | 1,3-Propene sultone | 0.5 | 0.97 | 2.62 |
| Example 5 | 3.600 | 0.396 | 1,3-Propene sultone | 0.5 | 1.33 | 3.70 |
| Comparative | 4.000 | 0.450 | 1,3-Propene sultone | 0.5 | 3.87 | 8.97 |
| Example 1 | | | | | | |
| Example 6 | 0.450 | 0.050 | 1,3-Propene sultone | 0.1 | 0.76 | 3.86 |
| Example 7 | 0.450 | 0.050 | 1,3-Propene sultone | 0.05 | 0.71 | 7.09 |
| Comparative | 0.450 | 0.050 | Not added | Not added | 0.60 | 8.24 |
| Example 2 | | | | | | |
| Example 8 | 0.450 | 0.050 | 1,3-Propene sultone | 1.0 | 0.88 | 2.04 |
| Example 9 | 0.450 | 0.050 | 1,3-Propene sultone | 2.0 | 0.97 | 3.28 |
| Example 10 | 0.450 | 0.050 | 1,3-Propene sultone | 3.0 | 2.84 | 6.64 |
| Example 11 | 0.485 | 0.015 | 1,3-Propene sultone | 0.5 | 1.46 | 2.44 |
| Example 12 | 0.480 | 0.024 | 1,3-Propene sultone | 0.5 | 0.93 | 2.52 |
| Example 13 | 0.420 | 0.084 | 1,3-Propene sultone | 0.5 | 0.69 | 2.88 |
| Example 14 | 0.390 | 0.117 | 1,3-Propene sultone | 0.5 | 0.60 | 2.99 |
| Example 15 | 0.360 | 0.144 | 1,3-Propene sultone | 0.5 | 0.55 | 3.93 |
| Example 16 | 0.450 | 0.050 | Methylene methane | 0.5 | 0.81 | 3.71 |
| | | | disulfonate | | | |
| Example 17 | 0.450 | 0.050 | Ethylene methane | 0.5 | 0.83 | 3.83 |
| | | | disulfonate | | | |
| Example 18 | 0.450 | 0.050 | Propylene methane | 0.5 | 0.92 | 3.96 |
| | | | disulfonate | | | |
| Example 19 | 0.450 | 0.050 | Pentene glycol | 0.5 | 0.86 | 3.93 |
| | | | sulfate | | | |
| Example 20 | 0.450 | 0.050 | 1,3-Propane sultone | 0.5 | 0.94 | 4.00 |

### 7. DISCUSSION

The amounts of gas before and after the confirmation test for the initial capacity and the increments of gas before and after the 60° C. cycle life test in Examples 1 to 20 and Comparative Examples 1 and 2 are shown in Table 1. In batteries added with a lithium phosphate compound containing LiPF₂(Oₓ)₂ and LiPF₄(Oₓ) in an amount that the content thereof becomes 0.05 to 4.0% by mass relative to the whole mass of the nonaqueous electrolyte (Examples 1 to 5), the initial amount of gas is less than or equal to 2.70 mL, and preferable results are obtained. And then, in batteries added with a lithium phosphate compound containing LiPF₂(Oₓ)₂ and LiPF₄(Oₓ) in an amount that the content thereof becomes 0.1 to 4.0% by mass relative to the whole mass of the nonaqueous electrolyte (Examples 2 to 5), the initial amount of gas is less than 1.5 mL, moreover, the increment of gas is less than 4.0 mL, and more preferable results are obtained. In particular, in batteries added with a lithium phosphate compound in an amount that the content thereof becomes 0.5 to 2.0% by mass (Examples 3 to 4), the initial amount of gas is less than 1.0 mL, the increment of gas is less than 3.0 mL, and especially more preferable results are obtained.

On the other hand, in a battery added with a lithium phosphate compound containing LiPF₂(Oₓ)₂ and LiPF₄(Oₓ) in an amount that the content thereof becomes 4.45% by mass relative to the whole mass of the nonaqueous electrolyte (Comparative Example 1), the initial amount of gas and the increment of gas are 3.87 mL and 8.97 mL, respectively, and the total amount thereof is 12.84 mL. In contrast, in a battery added with a lithium phosphate compound containing LiPF₂(Oₓ)₂ and LiPF₄(Oₓ) in an amount that the content thereof becomes 0.05% by mass relative to the whole mass of the nonaqueous electrolyte (Example 1), the initial amount of gas and the increment of gas are 2.70 mL and 9.74 mL, respectively, and the total amount thereof is 1.2.44 mL. In the battery in Example 1, as compared to the battery in Comparative Example 1, the initial amount of gas and the total amount of the initial amount of gas and the increment of gas are reduced.

It is thought that this is because when the amount of the lithium phosphate compound containing LiPF₂(Oₓ)₂ and LiPF₄(Oₓ) added is too large, the reaction of the compound with the electrode becomes excessive, and a large amount of gas associated with the decomposition of oxalic acid groups contained in LiPF₂(Oₓ)₂ and LiPF₄(Oₓ) is generated.

Moreover, in batteries added with 1,3-propene sultone as a cyclic sulfone compound in an amount that the content thereof becomes 0.05 to 3.0% by mass relative to the whole mass of the nonaqueous electrolyte (Example 3, Examples 6 and 7, and Examples 8 to 10), the increment of gas is less than 7.09 mL, and preferable results are obtained. Then, in batteries added with 1,3-propene sultone as a cyclic sulfone compound in an amount that the content thereof becomes 0.1 to 2.0% by mass relative to the whole mass of the nonaqueous electrolyte (Example 3 and Examples 6, 8 and 9), the initial amount of gas is less than 1.5 mL, the increment of gas is less than 4.0 mL, and more preferable results are obtained. In particular, in batteries added with a cyclic sulfone compound in an amount that the content thereof becomes 0.5 to 1.0% by mass (Examples 3 and 8), the initial amount of gas is less than 1.0 mL, the increment of gas is less than 3.0 mL, and especially more preferable results are obtained.

On the other hand, in a battery added with 1,3-propene sultone as a cyclic sulfone compound in an amount that the content thereof becomes 0% by mass relative to the whole mass of the nonaqueous electrolyte (Comparative Example 2), although the initial amount of gas and the increment of gas are 0.60 mL and 8.24 mL, respectively, it is not preferred because the capacity retention ratio after the 60° C. cycle life test is low since the cyclic sulfone compound is not contained in the nonaqueous electrolyte.

It is thought that this is because when the amount of the cyclic sulfone compound added is 0% by mass, a strong protective film, which is to be formed by the decomposition of a lithium phosphate compound and a cyclic sulfone compound, cannot be formed.

Moreover, when the amount of the cyclic sulfone compound added is greater than 3.0% by mass, it is not preferred because the cyclic sulfone compound is not completely dissolved in the nonaqueous electrolyte and further enhancement in performance cannot be expected.

In batteries prepared by changing the mixing ratio of LiPF₂(Oₓ)₂ and LiPF₄(Oₓ) (Examples 11 to 15), in the case where the content of LiPF₄(Oₓ) is set to 0.05 to 0.3 time the content of LiPF₂(Oₓ) (Examples 12 to 14), the initial amount of gas is less than 1.0 mL, the increment of gas is less than 3.0 mL, and more preferable results are obtained. On the other hand, in the case where the content of LiPF₄(Oₓ) is set to less than or equal to 0.05 time the content of LiPF₂(Oₓ)₂ (Example 11), there is a tendency for the initial amount of gas to increase. It is thought that this is because the amount of gas generated associated with the decomposition of oxalic acid groups is increased since the number of oxalic acid groups is increased as the content ratio of LiPF₂(Oₓ)₂ becomes higher. Moreover, in a battery in which the content of LiPF₄(Oₓ) is set to greater than or equal to 0.3 time the content of LiPF₂(Oₓ)₂ (Example 15), there is a tendency for the increment of gas to increase. Although the detailed mechanism has not yet been elucidated, it is thought that this is because the chemical composition of the protective film varies as the content ratio of LiPF₄(Oₓ) becomes higher, and the strength of the protective film is lowered.

In Examples 3 and 16 to 20 in which 1,3-propene sultone, methylene methane disulfonate, ethylene methane disulfonate, propylene methane disulfonate, pentene glycol sulfate, or 1,3-propane sultone is used as a cyclic sulfone compound, the initial amount of gas is less than 1.5 mL, the increment of gas is less than 4.0 mL, and preferable results are obtained. In particular, in a battery in which 1,3-propene sultone that is an unsaturated cyclic sultone compound is used as a cyclic sulfone compound (Example 3), the increment of gas is less than 3.0 mL and more preferable results are obtained. It is thought that this is because the chemical composition of the protective film varies by using the unsaturated cyclic sultone compound as a cyclic sulfone compound, and the strength of the protective film is enhanced.

From the above results, a nonaqueous electrolyte secondary battery including, in a nonaqueous electrolyte, a lithium phosphate compound containing lithium difluoro(bisoxalato) phosphate and lithium tetrafluoro(oxalato) phosphate in an amount greater than 0% by mass and less than or equal to 4.0% by mass relative to the whole mass of the nonaqueous electrolyte and a cyclic sulfone compound in an amount greater than 0% by mass and less than or equal to 3.0% by mass relative to the whole mass of the nonaqueous electrolyte can suppress both the gas evolution associated with the initial charge-discharge of the battery and the gas evolution at the time when the battery is used for a long period of time at a high temperature.

### DESCRIPTION OF REFERENCE SIGNS

1 Nonaqueous electrolyte secondary battery
3 Positive electrode plate (positive electrode)
4 Negative electrode plate (negative electrode)
5 Separator
6 Battery case
7 Battery lid
10 Positive electrode lead
11 Negative electrode lead

1. A nonaqueous electrolyte secondary battery comprising a nonaqueous electrolyte,
wherein a lithium phosphate compound and a cyclic sulfone compound are contained in the nonaqueous electrolyte,
the lithium phosphate compound is contained in an amount greater than 0% by mass and less than or equal to 4.0% by mass relative to the whole mass of the nonaqueous electrolyte,
the cyclic sulfone compound is contained in an amount greater than 0% by mass and less than or equal to 3.0% by mass relative to the whole mass of the nonaqueous electrolyte, and
the lithium phosphate compound comprises lithium difluoro(bisoxalato) phosphate represented by the following formula (1) and lithium tetrafluoro(oxalato) phosphate represented by the following formula (2).

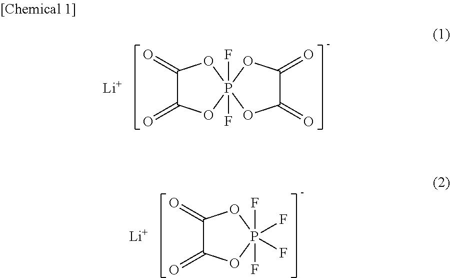

2. The nonaqueous electrolyte secondary battery according to claim 1, wherein the content of the lithium tetrafluoro(oxalato) phosphate is 0.05 to 0.3 time the content of the lithium difluoro(bisoxalato) phosphate.

3. The nonaqueous electrolyte secondary battery according to claim 1, wherein the cyclic sulfone compound is an unsaturated cyclic sultone compound represented by the following general formula (3). 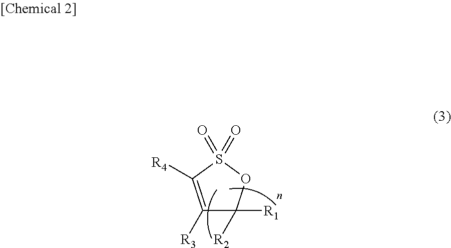
(In the formula, R1, R2, R3 and R4 each represent a hydrogen atom, a fluorine atom or a hydrocarbon group with 1 to 4 carbon atoms which may contain a fluorine atom, and n represents an integer of 1 to 3.)

4. A method for producing a nonaqueous electrolyte secondary battery prepared with a nonaqueous electrolyte, the method comprising the step of using the nonaqueous electrolyte containing a lithium phosphate compound in an amount greater than 0% by mass and less than or equal to 4.0% by mass relative to the whole mass of the nonaqueous electrolyte, containing a cyclic sulfone compound in an amount greater than 0% by mass and less than or equal to 3.0% by mass relative to the whole mass of the nonaqueous electrolyte, and the lithium phosphate compound containing lithium difluoro(bisoxalato) phosphate represented by the following formula (1) and lithium tetrafluoro(oxalato) phosphate represented by the following formula (2). [chemical structure]
